(19) United States
(12) Patent Application Publication
(10) Pub. No.: US 2006/0174499 A1
(43) Pub. Date: Aug. 10, 2006

(54) Device for determining an absolute angle of rotation

(75) Inventors: Norbert Staudt, Aschaffenburg (DE); Volker Stegmann, Aschaffenburg (DE); Guido Hirzmann, Sailauf (DE); Klaus Weigand, Steinau (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/336,076

(22) Filed: Jan. 20, 2006

(30) Foreign Application Priority Data
Feb. 7, 2005 (DE) 20 2005 001 887.2

(51) Int. Cl. B43L 5/00

(52) U.S. Cl. 33/1 R

(57) ABSTRACT

A device for determining an absolute angle of rotation of a rotation axis (12) includes a first measurement arrangement for measuring an angle of rotation in a limited first measurement range and a second measurement arrangement for determining an absolute angle range. The second measurement arrangement comprises a deflection element (20) and a rotation element. The deflection element undergoes a deflection dependent on the rotation of the rotation axis (12). The deflection, in turn, is converted into a rotation of the rotation element (22).

### TECHNICAL FIELD

The invention relates to a device for determining an absolute angle of rotation of a rotation axis.

### BACKGROUND OF THE INVENTION

Such a device having a first measurement arrangement for measuring an angle of rotation in a limited first measurement range and a second measurement arrangement for determining an absolute angle range is known from German patent application DE 198 18 799 A1. The first measurement arrangement comprises two magnetic pole rings arranged on the rotation axis. The pole rings have north and south poles alternately arranged adjacent to each other in circumferential direction, the rings having a different number of magnet poles. A fixed magnetoresistive sensor is associated with each ring. Although an angle of rotation can be determined in a very high resolution with the arrangement, the angle range is limited to a range of 0 degrees to a maximum of 180 degrees.

German patent application DE 198 18 799 A1 therefore proposes a second measurement arrangement having a Hall sensor by which the polarity of a detected magnet pole can be determined, in contrast to magnetoresistive sensors. Thereby, the range of absolute angle measurement can be extended to an interval of 0 degrees to 360 degrees. However, this is still not sufficient for determining the absolute angle of rotation of a steering wheel which can carry out several revolutions in both directions of rotation.

It is therefore an object of the invention to provide a device with which an absolute angle of rotation can be determined in a high resolution over a large measurement range, in particular over several revolutions.

### BRIEF SUMMARY OF THE INVENTION

According to the invention a device for determining an absolute angle of rotation of a rotation axis includes a first measurement arrangement for measuring an angle of rotation in a limited first measurement range and a second measurement arrangement for determining an absolute angle range. The second measurement arrangement comprises a deflection element and a rotation element. The deflection element undergoes a deflection dependent on the rotation of the rotation axis. The deflection, in turn, is converted into a rotation of the rotation element. In this way, angles of rotation greater than 360 degrees, which correspond to more than one revolution of the axis of rotation, can be measured easily, without an incremental signal evaluation (counting the revolutions or the like) being necessary. The initially provided conversion of the rotation into a deflection of the deflection element has the advantage that the deflection increases constantly and does not repeat itself like a rotation after 360 degrees. With a suitable transmission, a sufficient number of revolutions of the axis of rotation can be represented onto a single revolution of the rotation element through the subsequent conversion of the deflection into a rotation of the rotation element, such that for example the entire rotation angle range of a steering wheel can be detected. In combination with a first measurement arrangement which can measure a rotation of the axis of rotation in a limited angle range (e.g. 0 degrees to 180 degrees), a favourably priced device is thus produced, with which also the absolute steering wheel angle can be determined with a sufficiently high resolution directly after the supply voltage of the motor vehicle is switched on, without a previous relative movement of particular components.

The conversion of the revolution into a deflection can be achieved in accordance with a preferred embodiment of the invention in that the second measurement arrangement comprises a rotor having a spiral-shaped connecting link guide, the rotor being coupled to the rotation axis.

Matching this, the deflection element can be constructed as a rotatably mounted arm having an extension which engages into the connecting link guide. This design makes provision in a simple manner for a rotation of the axis of rotation to lead to a deflection of the deflection element corresponding to the rotation.

In the case of a motor vehicle steering wheel, it is efficient for the spiral-shaped connecting link guide to have a number of 360 degree turns which corresponds at least to the number of revolutions able to be carried out by the rotation axis (in this case the steering column).

The conversion of the deflection into a rotation can be realized by a design in which the arm has teeth which engage into matching counter teeth of the rotation element.

To measure the angle of rotation of the rotation element, it is advantageous that the rotation element is part of a rotation angle measurement unit.

The first measurement arrangement for measuring the rotation angle of the rotation axis in a limited first measurement range preferably comprises a further rotation element which is coupled to the rotation axis via teeth.

### BRIEF DESCRIPTION OF THE DRAWINGS

FIG. 1 shows diagrammatically the structure of a device according to the invention, in accordance with an example embodiment of the invention; and

FIG. 2 shows a connecting link guide of the device according to the invention.

### DETAILED DESCRIPTION OF THE PREFERRED EMBODIMENT

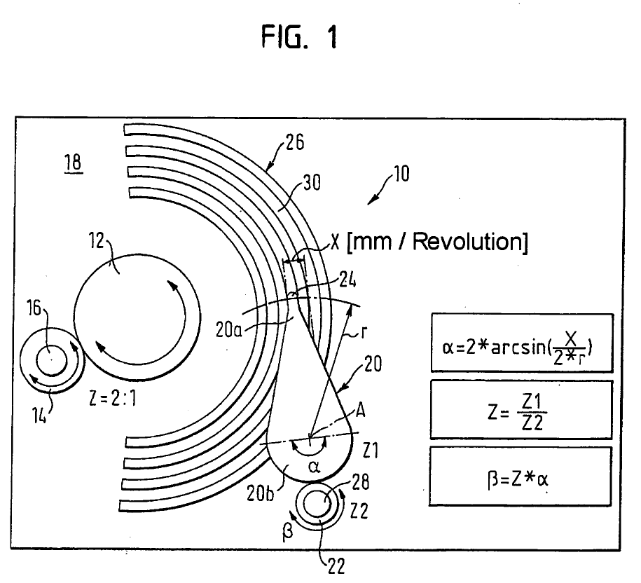

The invention is described in further detail by means of a device for measuring a steering wheel angle. The device 10 illustrated in FIG. 1 serves to determine the absolute angle of rotation of a steering wheel in a motor vehicle. The steering wheel (not shown) is coupled non-rotatably to a rotation axis 12 (steering column), which can perform several revolutions in both directions of rotation, starting from an initial position (central position of the steering wheel).

A first measurement arrangement is constructed as follows. A first rotation element 14 is coupled to the rotation axis 12 via teeth. In the illustrated example embodiment, the transmission ratio is 2:1, i.e. a rotation of the rotation axis 12 through 180 degrees leads to a complete 360 degree rotation of the first rotation element 14 (in the opposite direction of rotation). A permanent magnet 16, the rotation of which is measured conventionally in a contactless manner with a relatively high resolution, is arranged on the first rotation element 14. The first measurement arrangement thus allows a highly accurate measurement of the angle of rotation of the rotation axis 12 in a range from 0 degrees to 180 degrees.

In order to be able to indicate the actual absolute angle of rotation of the steering wheel, it is necessary to know the actual 180 degree angle range in which the angle lies which is measured by the first measurement arrangement. This is provided by a second measurement device, which must resolve double the number of 180 degree angle ranges depending on the number of revolutions which the steering wheel can carry out as a whole. In the case of a steering wheel which can carry out 3½ revolutions in both directions (i.e. a total of seven 360 degree revolutions), these are therefore 14 180 degree angle ranges, with four revolutions in both directions corresponding to 16 180 degree angle ranges.

The second measurement arrangement comprises a rotor 18 coupled to the rotation axis 12, a rotatably mounted arm 20 and a second rotation element 22. The rotor 18 may be coupled non-rotatably to the rotation axis 12, or the rotor 18 may be constructed in one piece with the rotation axis 12. The arm 20 is rotatable about a fixed axis A. An extension 24 is formed on a first free end 20a of the arm 20. The extension 24 engages into a connecting link guide 26 which is formed in the section of the rotor 18 running perpendicularly to the rotation axis 12. The second free end 20b of the arm 20, opposed to the first end 20a, is constructed as half of a circular disc, the central point of which lies on the bearing axis A of the arm 20. Teeth which engage into matching counter teeth of the second rotation element 22 are formed on the half circular disc. In a similar manner to the first rotation element 14, a permanent magnet 28, the rotation of which is measured conventionally in a contactless manner, is arranged on the second rotation element 22.

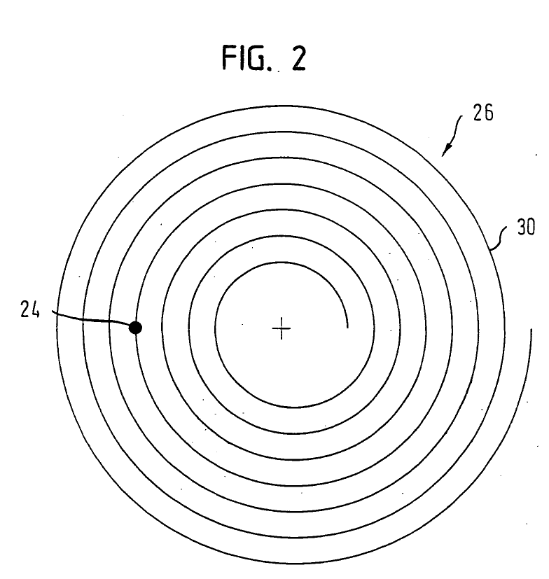

The connecting link guide 26 shown in top view in a stylized manner in FIG. 2 comprises a spiral groove 30 which in the illustrated example embodiment has a total of seven 360 degree turns. The number of 360 turns of the spiral groove 30 corresponds to the number of total revolutions which the steering wheel can carry out. In the present case—starting from the initial position of the rotation axis 12 (central position of the steering wheel)—this is 3½ revolutions to the left and 3½ revolutions to the right. In the central position of the steering wheel, the extension 24 is therefore at a point which corresponds to exactly half the total length of the spiral groove 30.

Upon a rotation of the steering wheel and of the rotor 18 which is coupled non-rotatably therewith, the first end 20a of the arm 20 is deflected inwards or outwards by the compulsory guidance of the extension 24 in the spiral groove 30. Therefore, the rotation of the steering wheel brings about a swivelling of the first end 20a of the arm 20 about the axis A, dependent on the total angle of rotation. A rotation of the second end 20b of the arm 20 about the axis A corresponds to the swivelling of the first end 20a of the arm 20. This rotation is transferred to the second rotation element 22 via the teeth of the second end 20b of the arm 20 and the counter teeth of the second rotation element 22.

The transmission between the second end 20b of the arm 20 and the second rotation element 22 is selected such that several revolutions of the rotation axis 12 in each direction can be represented to respectively less than one single revolution of the second rotation element 22, respectively.

To reliably determine the actual 180 degree angle range with components which are as simple as possible, a representation of the maximum possible revolutions of the rotation axis 12 in each direction to precisely one revolution of the second rotation element 22 is desirable. This means that the angle β, which corresponds to the maximum absolute rotation angle of the rotation axis 12 in one direction, is as far as possible to equal 360 degrees. The angle β can be influenced by the following parameters of the construction shown in FIG. 1; more precisely, the angle β becomes all the greater,

the greater the track distance X of the connecting link guide 26,

the smaller the radius r of the first end 20a of the arm 20,

the greater the number of teeth Z1 of the second end 20b of the arm 20,

the smaller the number of teeth Z2 of the second rotation element 22 is selected.

As already mentioned, a rotation angle in a measurement range of 0 degrees to 180 degrees can be detected with a high degree of accuracy by the first measurement arrangement. The second measurement arrangement can resolve sufficiently many 180 degree angle ranges to cover the entire rotation range of the steering wheel. The absolute rotation angle of the steering wheel is then determined by combining the measurement results of the first and the second measurement arrangement.

Both measurement arrangements perform a continuous measuring. Thus, the device according to the invention renders it possible to maintain the angle determination in a limited manner in the event that one of the measurement arrangements fails.

1. A device for determining an absolute angle of rotation of a rotation axis, the device including a first measurement arrangement for measuring an angle of rotation in a limited first measurement range and a second measurement arrangement for determining an absolute angle range, the second measurement arrangement comprising a deflection element and a rotation element, wherein the deflection element undergoes a deflection dependent on the rotation of the rotation axis, the deflection, in turn, being converted into a rotation of the rotation element.

2. The device according to claim 1, characterized in that the second measurement arrangement comprises a rotor having a spiral-shaped connecting link guide, the rotor being coupled to the rotation axis.

3. The device according to claim 2, wherein the deflection element is a rotatably mounted arm having an extension, the extension engaging into the connecting link guide.

4. The device according to claim 2, wherein the spiral-shaped connecting link guide has a number of 360 degree turns which corresponds at least to the number of revolutions able to be carried out by the rotation axis.

5. The device according to claim 3, wherein the arm has teeth which engage into matching counter teeth of the rotation element.

6. The device according to claim 5, wherein the rotation element is part of a rotation angle measurement unit.

7. The device according to claim 1, wherein the first measurement arrangement comprises a further rotation element which is coupled to the rotation axis viateeth.

8. The device according to claim 1, wherein both measurement arrangements enable a continuous measuring.
